(19) United States
(12) Patent Application Publication
(10) Pub. No.: US 2026/0255067 A1
(43) Pub. Date: Aug. 27, 2026

(54) IMAGE CAPTURING APPARATUS, CONTROL METHOD THEREFOR, AND STORAGE MEDIUM STORING CONTROL PROGRAM THEREFOR

(71) Applicant: CANON KABUSHIKI KAISHA, Tokyo (JP)

(72) Inventor: KEISUKE YANAGISAWA, Tokyo (JP)

(21) Appl. No.: 19/535,054

(22) Filed: Feb. 10, 2026

(30) Foreign Application Priority Data
Feb. 26, 2025 (JP) 2025-029039

(51) Int. Cl. H04N 23/72; H04N 23/63; H04N 23/71; H04N 23/73; H04N 23/74; H04N 23/76

(52) U.S. Cl. CPC H04N 23/72; H04N 23/633; H04N 23/71; H04N 23/73; H04N 23/74; H04N 23/76

(57) ABSTRACT

An image processing apparatus that allows a user to set imaging parameters appropriately in a case where a process to obtain an ND filtering effect is applied to each of areas in an image. The image capturing apparatus includes an image sensor to capture an image, a monitor to display information, a memory device that stores instructions, and a processor that executes the instructions to generate a synthesized image by synthesizing a plurality of images captured by the image sensor, set a first area and a second area different from the first area in at least one of the plurality of images and the synthesized image, obtain signal values for the first area and signal values for the second area, and display information based on the signal values obtained for the first area and information based on the signal values obtained for the second area on the monitor.

### BACKGROUND

### Field of the Technology

The aspect of the embodiments relates to an image capturing apparatus, a control method therefor, and a storage medium storing a control program therefor.

### Description of the Related Art

In a field of digital cameras, there is a known technique called a digital ND (Neutral Density) filtering process to obtain an effect equivalent to that of a physical ND filter. Further, Japanese Patent Laid-Open No. 2024-013938 (JP 2024-013938A) discloses a technique for obtaining different ND filtering effects, such as a GND filtering effect and a half ND filtering effect, for respective areas in an image. In addition, gradation ND (GND) synthesis is able to achieve a partial light reduction effect like an effect of a half ND filter by performing split exposure imaging with an exposure time shorter than a set shutter speed and performing weighted addition of a plurality of captured images for each area.

However, when the digital ND filtering process is applied to an image, it is necessary to set an ND factor in addition to a shutter speed, an aperture value, and an ISO speed that are set in normal imaging. Further, when a process using a GND filter or a half ND filter is executed, it is necessary to set the ND densities for respective areas. Therefore, the difficulty level of setting the imaging parameters is high.

In general, a histogram, a waveform monitor signal, and the like are used as determination criteria for setting the imaging parameters related to brightness. However, even if the brightness of the entire image after applying the ND filtering process is displayed by a histogram or a waveform monitor signal, it is difficult to determine whether each area has appropriate brightness.

### SUMMARY

The present disclosure provides an image processing apparatus that allows a user to set imaging parameters appropriately in a case where a process to obtain an ND filtering effect is applied to each of areas in an image.

Accordingly, an aspect of the embodiments provides an image capturing apparatus including an image sensor to capture an image, a monitor to display information, a memory device that stores a set of instructions; and at least one processor that executes the set of instructions to generate a synthesized image by synthesizing a plurality of images captured by the image sensor, set a first area and a second area different from the first area in at least one of the plurality of images and the synthesized image, obtain signal values for the first area and signal values for the second area, and display information based on the signal values obtained for the first area and information based on the signal values obtained for the second area on the monitor.

Features of the present disclosure will become apparent from the following description of embodiments with reference to the attached drawings. The following description of embodiments is described by way of example.

### BRIEF DESCRIPTION OF THE DRAWINGS

FIG. 1 is an external view of a digital camera including an image processing apparatus.

FIG. 2 is a block diagram illustrating a configuration of the digital camera including the image processing apparatus.

FIG. 3 is a flowchart illustrating a half ND synthesis process.

FIG. 4 is an explanatory diagram of an example of an exposure condition.

FIG. 5 is a flowchart illustrating a process of displaying a histogram for each image area according to a first embodiment.

FIG. 6 is a graph illustrating an example of a histogram.

FIG. 7 is a graph illustrating an example of a waveform monitor signal.

FIG. 8 is a flowchart illustrating a process of displaying a histogram for each image area according to a second embodiment.

FIG. 9 is a flowchart illustrating a process of setting an exposure condition based on a histogram according to a third embodiment.

### DESCRIPTION OF THE EMBODIMENTS

Hereinafter, embodiments of the present disclosure will be described in detail with reference to the attached drawings. However, the configuration described in the following embodiment is merely an example, and the scope of the present disclosure is not limited by the configuration described in the embodiment. In addition, although a plurality of features of the present disclosure are described in the following embodiments, all of the plurality of features are not necessarily essential to the disclosure, and the plurality of features may be arbitrarily combined. In the accompanying drawings, the same or similar components are denoted by the same reference numerals, and redundant description thereof will be omitted as much as possible.

ND synthesis means averaging of a plurality of obtained images, and half ND synthesis, which is a feature of the present disclosure, means synthesis of an averaged image (an image in a first area) and an accumulated image (an image in a second area). In the ND synthesis, first, an averaged image is generated by averaging split exposure images, and an accumulated image is generated by accumulating the split exposure images. After that, a synthesized image (an ND synthesized image) is generated by synthesizing the averaged image and the accumulated image in set areas. In addition, a digital camera will be described below as an example of an image capturing apparatus.

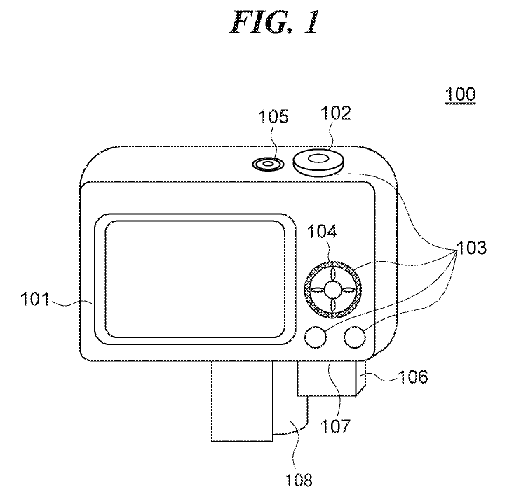

FIG. 1 is an external view of the digital camera 100 including an image processing apparatus. The digital camera 100 is one aspect of the image capturing apparatus, but the image capturing apparatus is not limited thereto. The digital camera 100 is provided with a monitor (display unit) 101. The monitor 101 is achieved by a display device such as an LCD or an organic EL display. The monitor 101 can function as an electronic viewfinder (EVF) by displaying an image captured by the digital camera 100. The monitor 101 displays an image, various other information, and the like.

The monitor 101 displays the following contents. That is, an image capturing mode selection screen, a menu screen, a setting screen for image capturing conditions, such as an ISO speed, an aperture value, a shutter speed, and an ND factor, and image data, such as a histogram and a waveform monitor signal, are displayed. The image capturing conditions, such as the shutter speed in image capturing and the ND factor, are displayed on the monitor 101 according to an operation of a selection switch or a confirmation switch so as to be superimposed on the menu screen or the live view screen displayed on the monitor 101. These can be set with a setting unit. The LCD of the monitor 101 may be a touch panel capable of a touch operation, and in this case, required information can be input and set not only by a switch operation but also by a touch operation on the touch panel.

A shutter button 102 can be pressed to give an image capturing instruction. The operation unit 103 receives various operations from a user. The operation unit 103 is configured by operation members, such as various switches, buttons, and the touch panel, that are disposed at a plurality of positions on a back surface and an upper surface of the digital camera 100. For example, the monitor 101 may be a touch panel so as to detect a touch operation to a display surface (a touch operation surface). A controller wheel 104 is one component of the operation unit 103 and can be rotated.

A power switch 105 is a push button that can be pressed to switch ON and OFF of the power and is provided on the upper surface of the digital camera 100. A recording medium 106 is a small storage device that stores information in a nonvolatile manner, such as a memory card or a USB memory, and is attachable to and detachable from the digital camera 100. A storage medium slot 107 is a slot for accommodating the recording medium 106. The storage medium slot 107 is disposed on a bottom surface of the digital camera 100. The recording medium 106 accommodated in the storage medium slot 107 enables communication of required information with the digital camera 100. A lid 108 closes an opening (not illustrated) of the storage medium slot 107.

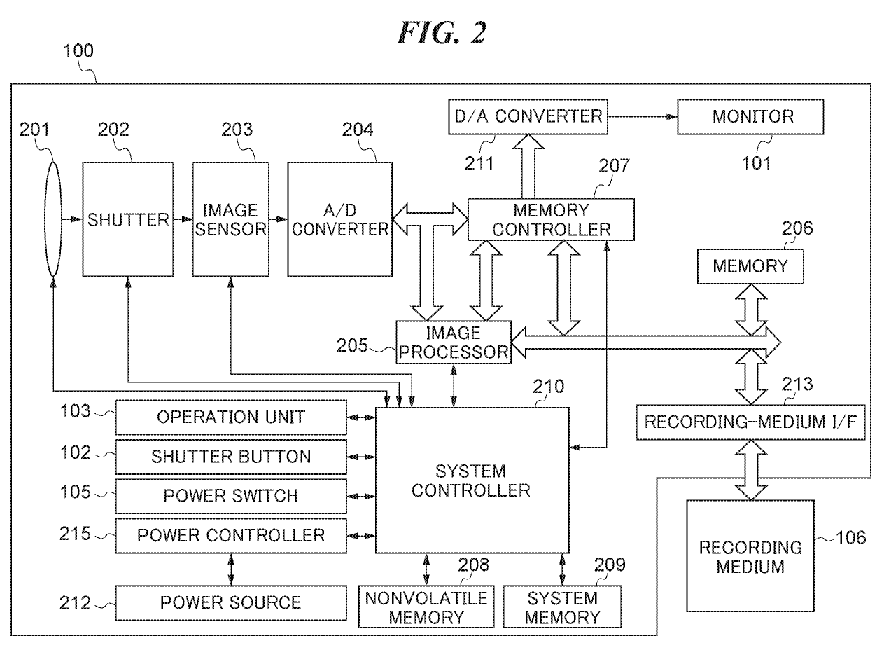

FIG. 2 is a block diagram illustrating one aspect of a configuration of the digital camera 100 (the image capturing apparatus) including the image processing apparatus. The digital camera 100 can capture a still image and a moving image. The digital camera 100 includes a taking lens 201, a shutter 202, an image sensor 203, and an A/D converter 204. The digital camera 100 includes an image processor 205, a memory 206, a memory controller 207, a D/A converter 211, the monitor 101, a recording-medium I/F 213, and a system controller 210. A nonvolatile memory 208, a system memory 209, the operation unit 103, the shutter button 102, the power switch 105, and a power controller 215 are connected to the system controller 210.

The taking lens 201 includes lens groups, such as a zoom lens group and a focus lens group, and a diaphragm. The shutter 202 performs opening and closing operations of a front curtain and a rear curtain to bring an imaging surface of the image sensor 203 into an exposure state or a light shielded state. The image sensor 203 converts an optical image formed on the imaging surface into an electrical signal, and is configured by a CCD element, a CMOS element, or the like. The A/D converter 204 converts an analog signal, which is an image signal output from the image sensor 203, into a digital signal.

The digital camera 100 includes, as its signal processing system, the image processor 205, memory controller 207, D/A converter 211, monitor 101, system controller 210, memory 206, and recording-medium I/F 213. The image processor 205 performs various image processes, such as a pixel interpolation process, a color conversion process, a gamma correction process, a digital gain process, and an image synthesis process on image data from the A/D converter 204 and image data from the memory controller 207. The image processor 205 further generates output data of a histogram or a waveform monitor signal based on the image data. The system controller 210 may execute a process to generate the output data of the histogram or the waveform monitor signal. The output data from the A/D converter 204 is written to the memory 206 via the image processor 205 and the memory controller 207 or via the memory controller 207. The memory 206 stores image data obtained by converting the image signal captured by the image sensor 203 into digital data by the A/D converter 204, image data to be displayed on the monitor 101, and the like.

The memory 206 has a storage capacity sufficient to store a predetermined number of still images, moving images for a predetermined time, and audio signals. The nonvolatile memory 208 is an electrically erasable and programable memory, and is achieved by, for example, an EEPROM, a flash memory, or the like. The nonvolatile memory 208 stores operation constants of the system controller 210, programs, and the like. Various processes according to the present disclosure are achieved by the system controller 210 executing the programs stored in the nonvolatile memory 208. For example, processes illustrated in various flowcharts described later in the present embodiment are achieved. The system memory 209 is a volatile memory such as a RAM. The system memory 209 stores the operation constants and variables of the system controller 210, and the program read from the nonvolatile memory 208.

The system controller 210 controls the entire digital camera 100. The system controller 210 controls, for example, the memory 206, the D/A converter 211, the monitor 101, and the like. This achieves a display control unit that displays, on the monitor 101, the image data written in the memory 206, and the histogram and waveform monitor signal generated by the image processor 205.

The power source 212 is configured by a primary battery such as an alkaline battery or a lithium battery, a secondary battery such as a NiCd battery, a NiMH battery, or a Li battery, an AC adapter, or the like. The recording-medium I/F 213 is an interface to communicate required information with the recording medium 106 such as a memory card or a USB memory. The power controller 215 includes a battery detection circuit, a DC-DC converter, a switch circuit for switching a block to be energized, and the like. The power controller 215 is connected to the power source 212 so as to control the power source 212 in order to detect whether a battery is mounted, a battery type, and a remaining battery level. The power controller 214 controls the DC-DC converter based on the detection result and an instruction from the system controller 210, and supplies a required voltage to each unit including the recording medium 106 for a required period.

The operation unit 103, the shutter button 102, and the power switch 105 connected to the system controller 210 are shown in FIG. 1, and these components apply control signals corresponding to user operations to the system controller 210.

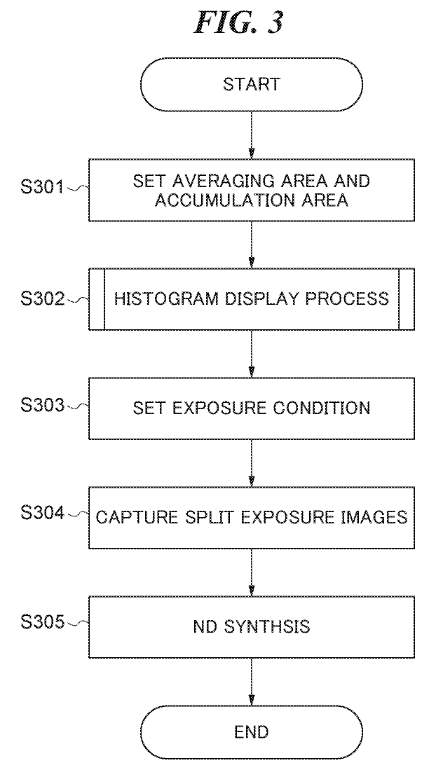

Next, a characteristic process of the present disclosure will be described with reference to FIG. 3. Unless otherwise specified, the process in each step of a flowchart in FIG. 3 is executed under the overall control by the system controller 210 executing a program. When a user sets an averaging mode, the process of the flowchart in FIG. 3 is started.

First, in a step S301, the system controller 210 sets an averaging area (a first area) and an accumulation area (a second area) specified by the user operating the operation unit 103. The areas may be set with using the touch operation of the touch panel of the monitor 101. At this time, a plurality of averaging areas and a plurality of accumulation areas may be set. In the following description, the averaging area shall be set at one place and the accumulation area shall be set at one place.

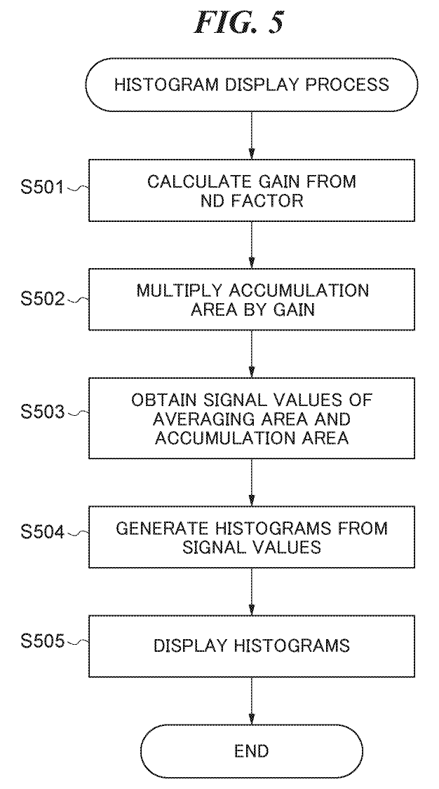

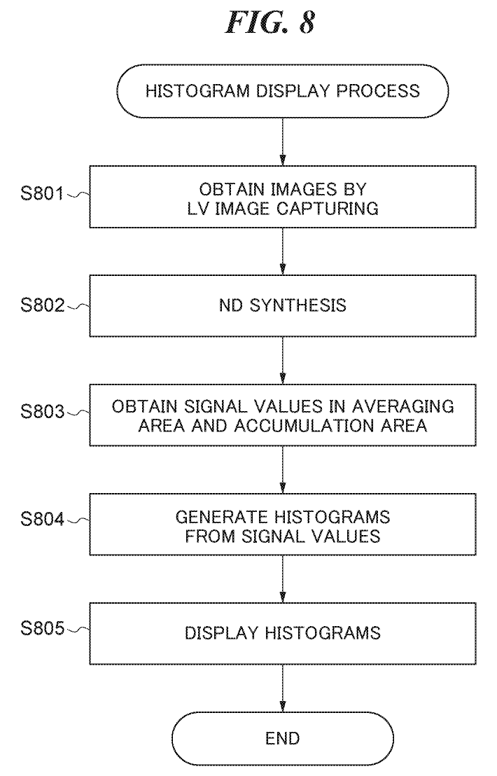

Next, in a step S302, the system controller 210 generates a histogram and displays it on the monitor 101. The system controller 210 may generate an image signal such as a waveform monitor signal instead of the histogram. The generation and display process of the histogram will be described later (see FIG. 5 and FIG. 8).

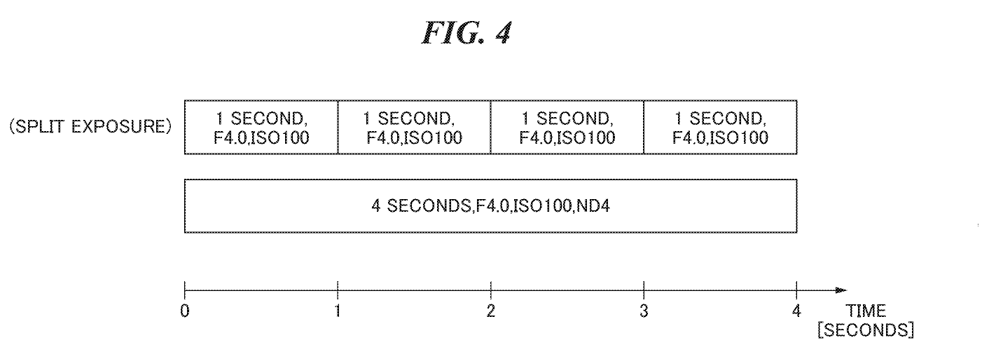

Next, in a step S303, the system controller 210 sets an exposure condition. The setting of the exposure condition will be described with reference to FIG. 4. FIG. 4 is an explanatory diagram showing an example of the exposure condition. FIG. 4 shows the example of the exposure condition set by the user in which a shutter speed is set to “4 seconds”, an aperture value is set to “F4. 0”, an ISO speed is set to “ISO100”, and an ND factor is set to “ND4”. Here, the ND factor will be described. A physical ND filter or a half ND filter reduces an object light in a target area to which the filter is attached. The ND factor indicates the degree of light reduction in the ND filter, and “ND2” means that the incident light is reduced by one step, “ND4” means that the incident light is reduced by two steps, and “ND8” means that the incident light is reduced by three steps.

In the present embodiment, since the light reduction effect of the ND filter is achieved by executing the image process without using the physical half ND filter, an exposure period defined by the shutter speed set by the user is shortened to lower the exposure corresponding to the light reduction effect. Therefore, although the values set by the user are used for the aperture value and ISO speed as the exposure condition, the shutter speed is set to be shorter than that set by the user in consideration of the light reduction effect corresponding to the ND factor. Specifically, when the shutter speed is “4 seconds” and the ND factor is “ND4” as shown in FIG. 4, the light reduction effect by two steps is necessary. Therefore, the system controller 210 sets “1 second” obtained by shortening the period of the shutter speed set by the user by two steps as the exposure condition of one split exposure image.

Further, the system controller 210 sets the number of images to be captured so that the exposure period obtained by adding up the plurality of slit exposure images is equivalent to the shutter speed set by the user. In the example shown in FIG. 4, since the exposure period of one split exposure image is “1 second” and the shutter speed set by the user is “4 seconds”, the system controller 210 sets the number of images to “4”. In the present embodiment, in order to simplify the setting of the exposure condition, the description will be made assuming that all the split exposure images have the same exposure. In addition, it is possible to smooth a blur of a moving object by shortening a non-exposure time between the end of exposure of a split exposure image and the start of exposure of the next split image as much as possible.

Next, in a step S304, the system controller 210 controls the shutter 202 and the image sensor 203 to capture a plurality of images (split exposure images) corresponding to the exposure condition set in the step S303. The system controller 210 may detect an imaging start instruction by detecting a full press of the shutter button 102 or by detecting expiration of a waiting time of a self-timer. It is assumed that the system controller 210 has executed an autofocus detection process (AF process) in detecting an imaging preparation instruction before detecting the imaging start instruction. Alternatively, the user may manually set an in-focus position using the operation unit.

Then, in a step S305, the system controller 210 controls the image processor 205 to perform ND synthesis of the split exposure images obtained in the step S304. The ND synthesis generates an ND synthesis image by averaging the split exposure images in the averaging area set in the step S301. In generating the ND synthesis image, first, an averaged image is generated by averaging the split exposure images, and an accumulated image is generated by accumulating the split exposure images. Thereafter, a synthesized image is generated by synthesizing the averaged image and the accumulated image according to the area set in the step S301. The synthesized image may be generated by performing gain-down to the averaging area set in the step S301 in the accumulated image obtained by accumulating the split exposure images.

In this manner, in the steps S303 to S305, first, the system controller 210 sets the exposure condition and captures a plurality of images corresponding to the set exposure condition. Then, the system controller 210 executes the process of averaging the plurality of images for the averaging area (first area).

Next, the histogram generation and display process according to the first embodiment will be described with reference to FIG. 5. FIG. 5 is a flowchart illustrating the process of displaying a histogram for each image area according to the first embodiment.

First, in a step S501, the system controller 210 calculates a gain by which the accumulation area set in the step S301 is multiplied on the basis of the ND factor set in step S303. The gain is determined so as to obtain an effect equivalent to gain-up by accumulation in the ND synthesis. The gain-up corresponds to increasing of the sensitivity of the digital camera 100. For example, a gain of one step is set for “ND2”, a gain of two steps is set for “ND4”, and a gain of three steps is set for “ND8”. That is, the gain is determined according to the number of steps of the ND factor. In this manner, the system controller 210 calculates the gain by which the accumulation area (second area) is multiplied on the basis of the ND factor in the step S501.

Next, in a step S502, the system controller 210 multiplies the accumulation area in one of the split exposure images by the gain calculated in the step S501, thereby generating a gain-up image. Accordingly, the image having brightness corresponding to the ND synthesis can be obtained. Since the image having brightness corresponding to the ND synthesis is obtained by multiplying the image by the gain, the image can be processed at a higher speed than in a case where a plurality of split exposure images are subjected to the ND synthesis. As a result, the system controller 210 can display the histogram on the monitor 101 in real time.

Next, in a step S503, the system controller 210 controls the image processor 205 to obtain signal values for each of the averaging area and the accumulation area in the gain-up image generated in the step S502. Examples of the signal values to be obtained include luminance signal values and color signal values.

Next, in a step S504, the system controller 210 maps the signal values of the averaging area and the accumulation area obtained in the step S503 to the histograms.

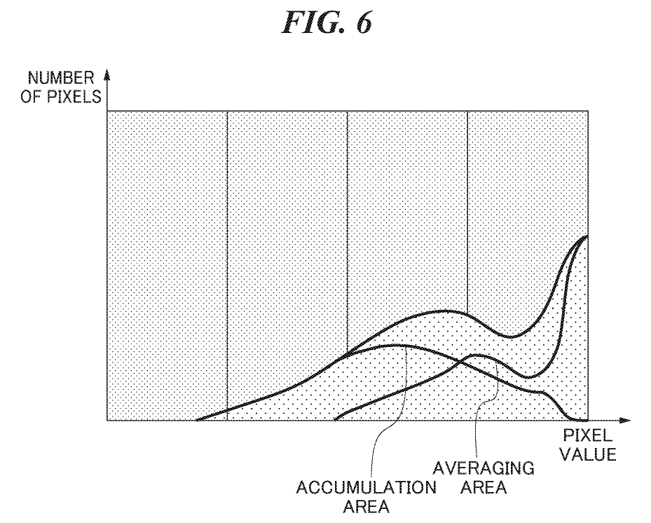

Then, in the step S505, the system controller 210 displays the histograms of the averaging area and the accumulation area mapped in the step S503 on the monitor 101. FIG. 6 shows examples of the histograms displayed on the monitor 101. In FIG. 6, the horizontal axis represents a pixel value and the vertical axis represents the number of pixels, and the relationship between a pixel value and the number of pixels is shown. As shown in FIG. 6, the histograms of the averaging area and the accumulation area may be displayed in a superimposed manner, or the histograms may be separately displayed for both areas. Further, a histogram of the entire image obtained by adding the histograms of the averaging area and the accumulation area may be displayed at the same time. By executing the steps S504 and S505, the system controller 210 is configured to include a unit that displays, on the monitor 101, information based on the signal values obtained for the averaging area (first area) and information based on the signal values obtained for the accumulation area (second area).

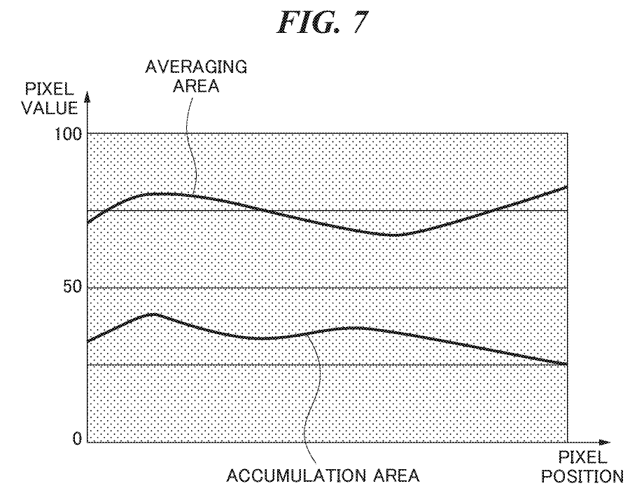

FIG. 7 is a graph illustrating an example of a waveform monitor signal. FIG. 7 shows the waveform monitor signals of the averaging area and accumulation area displayed on the monitor 110 by the system controller 210 instead of the histograms of averaging area and accumulation area shown in FIG. 6. In FIG. 7, the horizontal axis represents a pixel position and the vertical axis represents a pixel value, and the relationship between a pixel position and a pixel value in the image is shown. That is, the waveform monitor signal indicates a pixel value corresponding to a pixel position that is a position of a pixel in the image. In the way described above, the histogram display process of the half ND synthesis image in the first embodiment shown in FIG. 3 and FIG. 5 can be executed.

In the first embodiment, the process of generating and displaying the histogram after multiplying the averaging area in the image by the gain has been described. In contrast, the second embodiment is characterized in that a histogram is generated and displayed after a plurality of images obtained by simple image capturing are subjected to the ND synthesis. In second embodiment, the configuration of the digital camera 100 and the flowchart (see FIG. 3) of the ND synthesis process are similar to those of the first embodiment. Hereinafter, the histogram display process in the step S302, which is different from the first embodiment, will be described.

Next, the histogram generation and display process according to the second embodiment will be described with reference to FIG. 8. FIG. 8 is a flowchart illustrating the process of displaying a histogram for each image area according to the second embodiment. Unless otherwise specified, the process in each step of the flowchart in FIG. 8 is executed under the overall control of system controller 210 executing a program.

After setting the averaging area and the accumulation area in the step S301, the system controller 210 obtains a plurality of images by simple image capturing for live viewing (for LV) in a step S801. A simple captured image for the live viewing is a coarse image having a small number of pixels that is not stored as the captured image and is mainly used as an image for live viewing display or a calculation of image processing parameters.

Next, in a step S802, the system controller 210 performs the ND synthesis on the plurality of moving image images captured in the step S801 to generate an ND synthesis image. The detailed process of the ND synthesis is the same as the process in the step S305 in FIG. 3 in the first embodiment.

Next, in a step S803, the system controller 210 controls the image processor 205 to obtain signal values for each of the averaging area and the accumulation area in the ND synthesis image generated in the step S802. Examples of the signal values to be obtained include luminance signal values and color signal values.

The processes in steps S804 and S806 are the same as the processes in the steps S504 and S505 in FIG. 5 described in the first embodiment. As indicated in FIG. 8, the system controller 210 obtains the plurality of moving images for the live view, and averages the plurality of obtained moving images in the averaging area. In this way, according to the second embodiment, although the real-time property of the histogram display is lowered, it is possible to generate and display a highly accurate histogram close to the ND synthesis image stored in the recording medium 106 or the like.

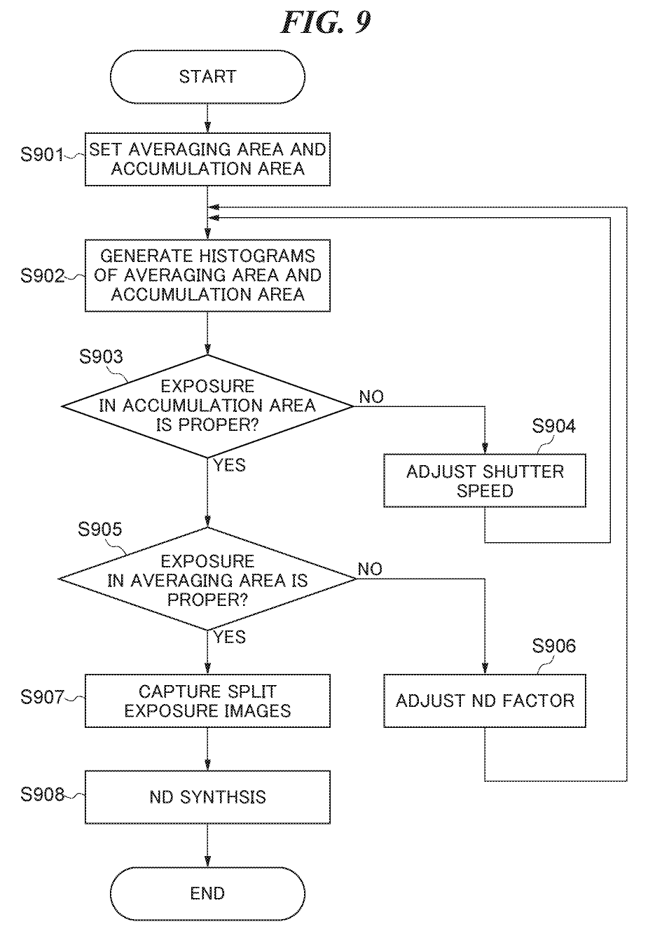

Next, a third embodiment will be described with reference to FIG. 9. The third embodiment is characterized in that the exposure condition is automatically adjusted based on information of the histograms in the averaging area and accumulation area. FIG. 9 is a flowchart illustrating a process related to the third embodiment. Unless otherwise specified, the process in each step of the flowchart in FIG. 9 is executed under the overall control of system controller 210 executing a program.

The process in a step S901 is similar to the process in the step S301 in the first embodiment. The process in a step S902 is a histogram generation process similar to the process in FIG. 5 described in the first embodiment or the process in FIG. 8 described in the second embodiment.

Next, in a step S903, the system controller 210 determines whether the exposure in the accumulation area is proper based on the histogram in the accumulation area generated in the step S902. When the system controller 210 determines that the exposure is proper (YES), the process proceeds to a step S905. On the other hand, when the system controller 230 determines that the exposure is not proper (NO), the process proceeds to a step S904.

For example, when a predetermined ratio or more of the pixels in the accumulation area are included in a predetermined range of the histogram, it is determined that the exposure in the accumulation area is proper. At this time, the system controller 210 determines that the exposure is “under” when the exposure is not proper and the number of low-luminance pixels is large, and determines that the exposure is “over” when the exposure is not proper and the number of high-luminance pixels is large.

When it is determined that the exposure in the accumulation area is “under” (NO in the step S903), the system controller 210 sets the shutter speed to longer seconds (longer time) than the currently set shutter speed in the step S904. In addition, when it is determined that the exposure in the accumulation area is “over” (NO in the step S903), the system controller 210 sets the shutter speed to shorter seconds (shorter time) than the currently set shutter speed in the step S904. At this time, the system controller 210 may change the exposure by changing the current exposure condition such as the aperture value and the ISO speed instead of the shutter speed.

Next, in the step S905, the system controller 210 determines whether the exposure in the averaging area is proper based on the histogram in the averaging area generated in the step S902. When the system controller 210 determines that the exposure is proper (YES), the process proceeds to a step S907. On the other hand, when the system controller 230 determines that the exposure is not proper (NO), the process proceeds to a step S906. At this time, the determination method may be similar to that in the step S903. For example, when a predetermined ratio or more of the pixels in the averaging area are included in a predetermined range of the histogram, it is determined that the exposure in the averaging area is proper. At this time, the system controller 210 determines that the exposure is “under” when the exposure is not proper and the number of low-luminance pixels is large, and determines that the exposure is “over” when the exposure is not proper and the number of high-luminance pixels is large.

When the exposure in the averaging area is determined to be “under” in the step S906, the system controller 210 sets the ND factor to a value smaller than the currently set value in the step S906. This corresponds to adjustment of the ND factor. In addition, when it is determined that the exposure in the averaging area is “over” in the step S905, the system controller 210 sets the ND factor to be larger than the currently set value in the step S906.

The processes in steps S907 and S908 are the same as the processes in the steps S304 and S305 in FIG. 3 described in the first embodiment. In this way, according to the third embodiment, it is possible to automatically adjust the exposure condition based on the information about the histograms in the averaging area and accumulation area.

As illustrated in FIG. 9, the system controller 210 determines whether the exposure in the accumulation area is proper with reference to the information based on the signal values obtained for the accumulation area (second area) in the steps S903 and S904. If the determination result is not proper, the system controller 210 adjusts the exposure condition. In addition, the system controller 210 determines whether the exposure in the averaging area is proper with reference to the information based on the signal values obtained for the averaging area (first area) in the steps S905 and S906. Then, if the determination result is not proper, the system controller 210 adjusts the ND factor that is a degree of light reduction.

As described above, according to the embodiments of the present disclosure, the user can appropriately and easily set parameters related to brightness, such as the shutter speed and the ND factor, on the basis of the displayed histogram and waveform monitor signal. In addition, the storage medium storing the program that causes a computer to execute the above process is also provided.

In the above embodiments, the execution of the process in the digital camera 100 has been described, but the process according to the present disclosure is not limited to the digital camera 100. For example, the present disclosure may be applied to a portable device incorporating an image sensor, and may be applied to a network camera capable of capturing an image, various electronic apparatuses having an image capturing function, and the like.

According to the present disclosure, the user can appropriately set the imaging parameters in a case where the process to obtain the ND filtering effect is applied to each of areas in an image.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-029039, filed February 26, 2025 which is hereby incorporated by reference herein in its entirety.

What is claimed is:

1. An image capturing apparatus comprising:
an image sensor to capture an image;
a monitor to display information;
a memory device that stores a set of instructions; and
at least one processor that executes the set of instructions to:
generate a synthesized image by synthesizing a plurality of images captured by the image sensor;
set a first area and a second area different from the first area in at least one of the plurality of images and the synthesized image;
obtain signal values for the first area and signal values for the second area; and
display information based on the signal values obtained for the first area and information based on the signal values obtained for the second area on the monitor.

2. The image capturing apparatus according to claim 1, wherein the at least one processor executes instructions in the memory device to:
allow setting of an exposure condition in capturing an image;
capture the plurality of images with the image sensor in accordance with the exposure condition; and
average the plurality of images for the first area and accumulate the plurality of images for the second area in generating the synthesized image.

3. The image capturing apparatus according to claim 2, wherein the at least one processor executes instructions in the memory device to:
calculate a gain by which the second area is multiplied; and
multiply the second area in one of the plurality of images by the gain.

4. The image capturing apparatus according to claim 2, wherein the plurality of images are captured for live viewing.

5. The image capturing apparatus according to claim 2, wherein the at least one processor executes instructions in the memory device to:
determine whether exposure in the second area satisfies a predetermined condition by referring to information based on the signal values obtained for the second area; and
adjust an exposure condition in capturing the plurality of images in a case where it is determined that the exposure in the second area does not satisfy the predetermined condition.

6. The image capturing apparatus according to claim 5, wherein the exposure condition includes at least one of a shutter speed, an aperture value, and an ISO speed.

7. The image capturing apparatus according to claim 1, wherein the at least one processor executes instructions in the memory device to:
determine whether exposure in the first area satisfies a predetermined condition by referring to information based on the signal values obtained for the first area; and
adjust a degree of light reduction by an image process in a case where it is determined that the exposure in the first area does not satisfy the predetermined condition.

8. The image capturing apparatus according to claim 7, wherein the at least one processor executes instructions in the memory device to adjust an ND factor to adjust the degree of light reduction.

9. The image capturing apparatus according to claim 1, wherein the information based on the signal values obtained for each of the first area and the second area is a histogram showing a relationship between a pixel value and a number of pixels.

10. The image capturing apparatus according to claim 1, wherein the information based on the signal values obtained for each of the first area and the second area is a waveform monitor signal showing a relationship between a pixel position in an image and a pixel value.

11. The image capturing apparatus according to claim 1, wherein the signal values are luminance signal values or color signal values.

12. The image capturing apparatus according to claim 1, wherein the at least one processor executes instructions in the memory device to set an exposure condition in accordance with a degree of light reduction in capturing an image.

13. A control method for an image capturing apparatus, the control method comprising:
capturing a plurality of images;
generating a synthesized image by synthesizing the plurality of images;
setting a first area and a second area different from the first area in at least one of the plurality of images and the synthesized image;
obtaining signal values for the first area and signal values for the second area; and
displaying information based on the signal values obtained for the first area and information based on the signal values obtained for the second area on a monitor.

14. A non-transitory computer-readable storage medium storing a control program causing a computer to execute a control method for an image capturing apparatus, the control method comprising:
capturing a plurality of images;
generating a synthesized image by synthesizing the plurality of images;
setting a first area and a second area different from the first area in at least one of the plurality of images and the synthesized image;
obtaining signal values for the first area and signal values for the second area; and
displaying information based on the signal values obtained for the first area and information based on the signal values obtained for the second area on a monitor.
